(19) United States
(12) Patent Application Publication
(10) Pub. No.: US 2008/0001095 A1
(43) Pub. Date: Jan. 3, 2008

(54) ADAPTIVE IMAGING SYSTEM

(76) Inventors: Oliver Richard Astley, Clifton Park, NY (US); John Eric Tkaczyk, Delanson, NY (US); Naresh Kesavan Rao, Clifton Park, NY (US); James Walter LeBlanc, Niskayuna, NY (US); Wen Li, Clifton Park, NY (US); Yanfeng Du, Rexford, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/427,534

(22) Filed: Jun. 29, 2006

(51) Int. Cl. G01T 1/16

(52) U.S. Cl. 250/370.09

(57) ABSTRACT

An adaptive imaging system includes a detector receiving energy transmitted through a target and generating electrical charge pulses at a pulse rate indicative of an intensity of received energy. The system also includes a switch for selectively coupling the charge pulses from one or more pixel elements of the detector to a charge pulse counter for counting the charge pulses and a charge pulse integrator for integrating the charge pulses. In addition, the system includes a prediction module for predicting a charge pulse rate expected to be produced by the detector and for operating the switch to selectively couple the charge pulses to the counter and the integrator responsive to a predicted charge pulse rate.

### FIELD OF THE INVENTION

The present invention is generally related to imaging systems, and, more particularly, to an adaptive imaging system for automatically selecting a mode of operation responsive to an expected operating condition of the system.

### BACKGROUND OF THE INVENTION

In a conventional x-ray imaging system, x-rays passing through a target are converted into electrical charge pulses by an x-ray detector responsive to a number of x-ray photons received at the detector. The electrical charge pulses are then processed to determine an intensity of x-rays reaching the detector, which may then be further processed to construct an X-ray image. Such x-ray imaging systems are commonly used for computer tomography (CT) in the medical field. Processing of the charge pulses to generate images may be accomplished using a conventional charge pulse counting technique or a conventional charge pulse integration technique. When an x-ray flux though an imaged target is relatively low, resulting in a number of charge pulses produced by the x-ray detector being relatively low, a counting technique may provide a better measurement of the x-ray photons received. Alternatively, when an x-ray flux though an imaged target is relatively high, resulting in a number of charge pulses produced by the x-ray detector being relatively high, an integration technique may provide a better measurement of the x-ray photons received.

### BRIEF DESCRIPTION OF THE DRAWINGS

FIG. 1 is a block diagram of an example embodiment of an adaptive imaging system.

FIG. 2 is a block diagram of another example embodiment of an adaptive imaging system.

FIG. 3 is a block diagram of another example embodiment of an adaptive imaging system.

### DETAILED DESCRIPTION OF THE INVENTION

Imaging systems that provide manual switching between counting and integration techniques have been proposed, but the user of such systems is required to configure the system prior to performing a scan based on whether a relatively low pulse rate or a relatively high pulse rate is expected. Consequently, such imaging systems require a user to know in advance which processing technique will provide the desired results. When an incorrect decision is made whether to use a counting or an integration technique, rescanning of the target may need to performed using the correct technique. To overcome these and other limitations, the inventors have developed an adaptive switching method and system that automatically predicts an appropriate pulse rate processing technique and dynamically switches between appropriate techniques to provide improved imaging. The invention advantageously allows switching between processing techniques on-the-fly during a scan

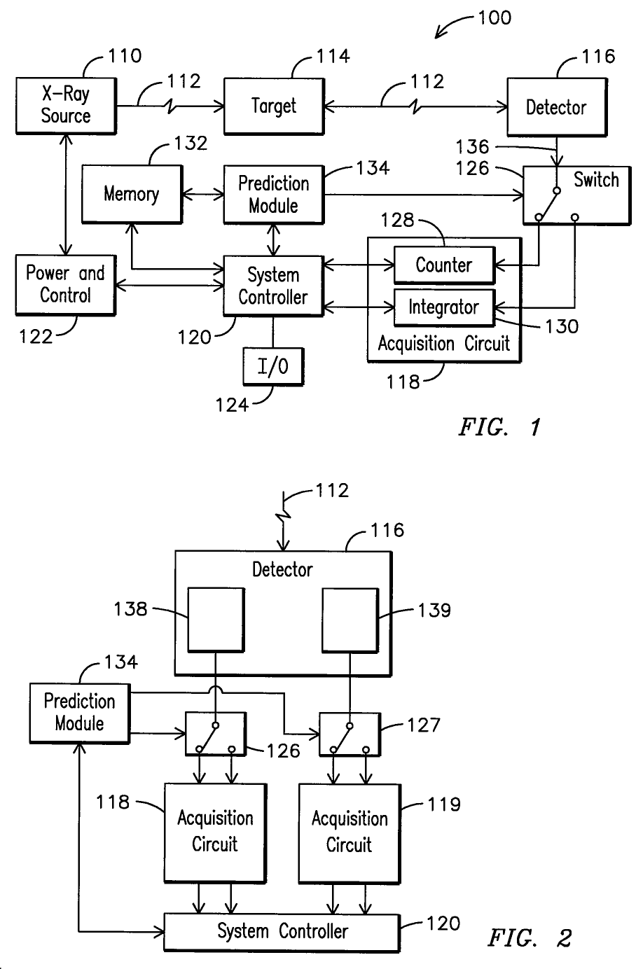

FIG. 1 is a block diagram of an example adaptive imaging system according to an embodiment of the invention. As shown in FIG. 1, imaging system 100 may include an energy source, such as x-ray source 110, that is capable of generating and emitting energy, such as in the form of photons 112, suitable for producing an image. In one or more alternative embodiments, x-ray source 110 may be any type of source capable of emitting particles or waves suitable for producing an image, and the scope of the claimed subject matter is not limited in this respect. Photons 112 may impinge upon target 114, which may be, for example an animal and/or human target where imaging system 100 is utilized in medical applications. Alternatively, target 114 may be any suitable target where an image of target 114 may be desirable, for example in inspection of manufactured parts, although the scope of the claimed subject matter is not limited in this respect. At least a portion of photons 112 may pass through target 114 at varying flux levels corresponding at least in part to a density of portions of target 114 where such photons 112 passing through target 114 may be detected by detector 116. Based at least in part on the varying flux levels of photons 112 detected by detector 116, detector 116 may provide an detector output signal 136, such as electrical charge pulses, to acquisition circuit 118 that is capable of generating an image, and/or data representative of an image, of target 114 from the detector output signal 136. In an embodiment of the invention, the acquisition circuit 118 may comprise a counter 128 and integrator 130 for performing pulse counting and pulse integration, respectively. A switch 126 may be provided to selectively switch the detector output signal 136 between the counter 128 and integrator 130.

System controller 120 may receive image information from at least one of the counter 128 and integrator 130 of the acquisition circuit 118 and may perform various control and processing functions for imaging system 100. For example, system controller 120 may couple with power and control unit 122 to control the operation of x-ray source 110, such as a position of the x-ray source and detector 116 relative to target 114. Likewise, system controller 120 may control the operation of acquisition circuit 118 and/or detector 116, and may be further coupled to an input/output (I/O) system 124. I/O system 124 may include one or more controls for allowing an operator to operate imaging system 100, and/or may couple to one or more devices for displaying and/or storing images of target 114 captured by detector 116. For example, I/O system 124 may couple to a liquid-crystal display (not shown) or the like for displaying images captured by detector 116. Furthermore, I/O system 124 may couple to a hard disk drive or other types of storage media for storing images captured by detector 116. In one or more embodiments, I/O system 124 may couple to a network adaptor, modem, and/or router (not shown), for example to send images captured by detector to other devices and/or nodes on a network. Furthermore, such a network adaptor, modem, and/or router may allow a remote operator to download and/or view images capture by detector 116, for example as captured and stored as data files, and/or to receive and/or view such images in real-time or in near real-time, and/or to otherwise control the operation of imaging system 100 from a remote location for example from a machine coupled to imaging system 100 via the Internet. However, these are merely examples of embodiments for control of and/or communication with imaging system 100, and the scope of the claimed subject matter is not limited in these respects.

In one or more embodiments, system controller 120 may include at least one or more processors for executing control functions of imaging system 100, for controlling the image capturing process of imaging system 100, and/or for electronic processing of images capture by detector 116. In one or more embodiments, system controller 120 may include one or more general purpose processors having one or more processor cores, and in one or more embodiments system controller 120 may include one or more special purpose processors such as a digital signal processor, for example to perform image processing on images captured by detector 116. In one or more embodiments, system controller 120 may comprise a general purpose computer platform, workstation, and/or server, and in one or more alternative embodiments, system controller 120 may comprise a special purpose platform designed for imaging tasks. However, these are merely example embodiments of system controller 120, and the scope of the claimed subject matter is not limited in these respects.

In one or more embodiments, detector 116 may be a semiconductor based detector 116, such as a pixel array of anode contacts on a semiconductor crystal. Typically an electric voltage is applied between the pixel anode contacts on one side of the crystal and a common cathode contact on an opposite side of the crystal. Each pixel contact may be capable of detecting photons 112 emitted from x-ray source 110 at specific locations on an incident surface of the detector. Such a semiconductor based pixel detector may be referred to as a direct conversion detector capable of converting photons 112 from x-ray source 110 into an electrical signal representative of an image of target 114. Examples of direct conversion semiconductor detector materials may include cadmium telluride, cadmium zinc telluride, silicon and/or gallium arsenide.

In another embodiment, an indirect conversion detector may use a combination of a scintillator material and a silicon diode array. The scintillator first converts the incident photons emitted from the x-ray source 110 to light photons and the diode converts the light photons to charge. The subsequent processing of the signal from detector 116 in the acquisition circuit 118 is the same whether the detector 116 is a direct or indirect detector. The detectors in such an direct or indirect array may include corresponding transistors, for example thin film transistors (TFTs) and other circuits for controlling the routing of charge from each pixel in the array of the detector, to a readout circuit for forming signals from the detector based at least in part on the flux and/or intensity of photons 112 impinging on the detector.

In one or more embodiments, detector 116 may comprise multiple sensors, such as an array of pixels, or an array of pixels where each pixel is composed of multiple pixel elements 138, 139 as shown in FIG. 2. The multiple sensors may comprise a combination of different types, direct or indirect and pixel elements of different size and shape. The multiple sensors may also be comprised of superimposed pixel elements on different layers in a detector built from multiple sensor layers. Each pixel element 138, 139, or at least some pixel elements, may be served by individual acquisition circuits 118, 119, for example, via switches 126, 127. Alternately, through a different configuration of the switch 126 the pixel elements can be routed into a single acquisition channel such that the signal charges from the combined elements are processed together.

Returning to FIG. 1, a prediction module 134 may be provided for automatically selecting a mode of operation, such as a counting or integration mode, responsive to an expected operating condition, such as an expected detector output signal 136 of the system 100. In an aspect of the invention, the prediction module 134 may be configured for automatically switching the detector output signal 136 during an image scanning operation to ensure that a desired signal processing method, such as charge pulse counting or charge pulse integration, is used by the system 100 to achieve a desired image quality. For example, when a relatively low charge rate is expected, the switch 126 may be commanded by the prediction module 134 to provide the detector output signal 136 to the counter 128. When a relatively high charge rate is expected, the switch 126 may be commanded by the prediction module 134 to provide the detector output signal 136 to the counter 128. Similarly, for a detector with multiple sensors and pixel elements 138,139, the prediction module 134 may configure the switch 126 and route a signal charge appropriately to the acquisition circuit 118 to achieve a desired image quality. For example, when a relatively low charge rate is expected, the switch 126 may be configured to sum the signals from the combined elements 138,139, to the acquisition circuit 118. When a relatively high charge rate is expected, only a subset of the elements may be routed in this manner.

Prediction module 134 may take any form known in the art, for example an analog or digital microprocessor or computer, and it may be integrated into or combined with one or more controllers used for other functions related to the imaging system control. The steps necessary for predicting charge pulse rates and automatically controlling switching between counting and integrating may be embodied in hardware, software and/or firmware in any form that is accessible and executable by processor 24 and may be stored on any medium, such as memory 132, that is convenient for the particular application.

In an aspect of the invention, the prediction module 134 may be configured for automatically predicting an expected electrical charge pulse rate based on a previous pulse charge rate sensed by the system 100. For example, the prediction module 134 may be in communication with a memory 132 storing previously acquired detector data, such as previously acquired charge pulse rate data, to be used for making a prediction regarding a expected detector output signal 136. The prediction module 134 may be further configured for determining a trend in the previous signal charge pulse rates indicative of an expected charge pulse rate. For example, previously acquired detector pulse rate may be extrapolated to identify an expected charge pulse rate. The expected charge pulse rate may be compared to a predetermined charge signal rate threshold, for example stored in memory 132, to determine which signal processing method should be used. An expected charge pulse rate below the predetermined charge signal rate threshold may indicate a pulse counting technique should be used, whereas an expected charge pulse rate above the predetermined charge signal rate threshold may indicate a pulse integration technique should be used.

In another aspect of the invention, the prediction module 134 may be configured for predicting an expected pulse rate responsive to an expected x-ray flux through the target 114. For example, a prediction of an expected pulse rate may be determined based on a position of the detector 116 relative to the target 114 and an internal representation of the target's geometry. Target geometry may be established during scout scans taken before performing a detailed imaging scan. The target geometry may be associated with a position of the detector 116 and/or source 110 provided, for example, by the power and control unit 122, and the detector position associated geometry information may be stored in memory 132 for access by the prediction module 134 during imaging. For example, the internal representation can be the size and shape of an ellipse-shaped water body giving the equivalent x-ray attenuation as the target in anterior-posterior and lateral projections. Scout views of the target 114 in the anterior-posterior and lateral directions may be used to establish the major and minor axis parameters of the ellipse and its position between x-ray source 110 and detector 116. Alternately, a low dose CT scan may be used to capture the map of pulse rate versus position of the detector 116 relative to the target 114. As the target is scanned, the prediction module 134 may access the detector position associated geometry information stored in memory 134 and use present position information provided by the power and control unit 122 to predict an expected pulse rate based on an expected flux though the target 114 at the present position. When a relatively low level of flux is expected based on the present position, the prediction module 134 may control the switch 126 for counting charge pulses, and when a relatively high level of flux is expected, the prediction module 134 may control the switch 126 for integrating charge pulses.

In another aspect, the prediction module 134 may be configured for predicting a charge pulse rate based on a desired anatomical region of the target to be scanned, such as a brain scan, a heart scan, a lung scan, etc. In yet another aspect, the prediction module 134 may be configured for predicting a charge pulse rate based on statistical data compiled from previous scans. For example, statistical data corresponding to x-ray flux rates may be established based on actual scan data previously acquired. The statistical data may then be used to determine an appropriate scanning technique for a target to be scanned based what the statistical x-ray flux rates have been for similar scans. The statistical data may vary according to a patient size, a type of scan, and/or a location of detector pixel relative to a patient.

In another aspect of the invention wherein the imaging system 100 progressively scans the target 114 for acquiring respective imaged slices of the target 114, the predictive module 134 may be configured for monitoring previous charge pulse rates of previously imaged slices of the target 114 to predict an expected charge pulse rate. For example, the predictive module 134 may be configured for determining a charge pulse rate trend based on one or more previously acquired slices and then predicting an expected charge pulse rate for a next slice to be scanned based on the trend.

In another embodiment of the invention shown in FIG. 2, the detector 116 may include an array of pixel elements 138, 139 served by respective acquisition circuits 118, 119. In this embodiment, the prediction module 134 may be configured for monitoring charge pulse rates generated by nearby pixel elements, such as adjacent pixels, to predict an expected charge pulse rate of a desired pixel. For example, a previous or current charge pulse rate for first pixel element 139 may be used as a basis for a prediction of an expected charge pulse rate for a second pixel element 138. Information regarding the charge pulse rates of adjacent pixel elements may be provided to the prediction module 134 via system controller 122 and may be stored in memory 132 for use by the prediction module 134.

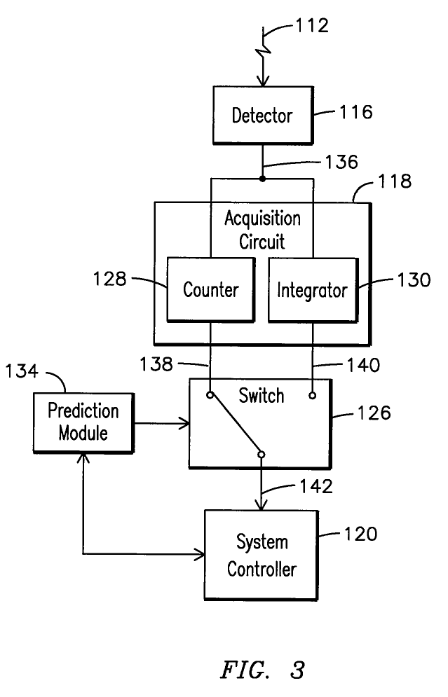

In another aspect of the invention shown in FIG. 3, the detector output signal 136 may be parallel processed by the counter 128 and the integrator 130 and a counter output 138 or an integrator output 140 may be selected for further processing based on a predicted pulse charge rate. As shown in FIG. 3, the acquisition circuit 118 may direct the detector output signal 136 to both the counter 128 and the integrator 130. The counter 128 and the integrator 130 may generate the counter output 138 and the integrator output 140, respectively, responsive to a charge pulse rate received from the detector 116. The switch 126 may be provided for selectively providing the counter output 138 and the integrator output 140 to the system controller 122, based on a charge pulse rate expected to be produced by the x-ray detector 116. The prediction module 134 may be configured for predicting a charge pulse rate expected to be produced by the x-ray detector 116 according to the techniques described previously, and may operate the switch 126 to selectively choose the counter output 138 and the integrator output 140 as an acquisition circuit output 142.

Based on the foregoing specification, the invention may be implemented using computer programming or engineering techniques including computer software, firmware, hardware or any combination or subset thereof, wherein the technical effect is to provide an adaptive imaging system for automatically selecting a mode of operation responsive to an expected operating condition of the system. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a microprocessor, to create a computer system or computer sub-system embodying the method of the invention. An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention.

While various embodiments of the present invention have been shown and described herein, such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. An adaptive imaging system comprising:
a detector receiving energy transmitted through a target and generating electrical charge pulses at a pulse rate indicative of an intensity of received energy;
a switch for selectively coupling the charge pulses from one or more pixel elements of the detector to a charge pulse counter for counting the charge pulses and a charge pulse integrator for integrating the charge pulses; and
a prediction module for predicting a charge pulse rate expected to be produced by the detector and for operating the switch to selectively couple the charge pulses to the counter and the integrator responsive to a predicted charge pulse rate.

2. The system of claim 1, wherein the prediction module is configured for predicting the charge pulse rate based on previous electrical charge pulse rates generated by the detector.

3. The system of claim 2, wherein the detector comprises at least two sensors receiving energy from the target, each sensor providing respective electrical charge pulses responsive to the received energy, wherein the prediction module is further configured for predicting a charge pulse rate of a first sensor based on a charge pulse rate of a second sensor of the detector proximate the first sensor.

4. The system of claim 1, wherein the detector comprises at least two sensors receiving energy from the target, each sensor providing respective electrical charge pulses responsive to the received energy, wherein the prediction module is configured for predicting a charge pulse rate of a first sensor based on a charge pulse rate of a second sensor of the detector proximate the first sensor.

5. The system of claim 1, wherein the detector comprises a plurality of sensors receiving energy from the target, each sensor providing respective electrical charge pulses responsive to the received energy, wherein the prediction module is configured for predicting a charge pulse rate based on at least one of the sensors.

6. The system of claim 1, wherein the prediction module is configured for predicting a charge pulse rate based on a position of the detector relative to the target.

7. The system of claim 1, wherein the prediction module is configured for predicting a charge pulse rate based on statistical data compiled from previously acquired imaging scans.

8. The system of claim 1, wherein the detector is manipulated for progressively scanning the target for acquiring respective imaged slices of the target, wherein the prediction module is configured for predicting a charge pulse rate based on charge pulse rates received for previously imaged slices of the target.

9. The system of claim 1, wherein the prediction module is configured for predicting a charge pulse rate based on a scout scan of the target.

10. The system of claim 1, wherein the prediction module is configured for predicting a charge pulse rate based on a desired anatomical region of the target to be imaged.

11. An adaptive imaging system comprising:
a detector receiving energy transmitted through a target and producing electrical charge pulses at a pulse rate indicative of respective intensities of a received energy;
an acquisition circuit comprising a charge pulse counter for counting a plurality of charge pulses produced by the detector and generating a count signal and a charge pulse integrator for integrating a plurality of charge pulses produced by the detector and generating an integration signal;
a switch for selecting the count signal or the integration signal as an output of the acquisition circuit; and
a prediction module for predicting a charge pulse rate expected to be produced by the detector and for operating the switch to select the count signal or the integration signal as the output of the acquisition responsive to a predicted charge pulse rate.

12. An adaptive imaging method comprising:
automatically predicting an electrical charge pulse rate expected to be produced by a detector receiving energy from a target and providing electrical charge pulses at a rate indicative of an intensity of the received energy; and
selectively directing the charge pulses from one or more pixel elements of the detector to a charge counter and a charge integrator responsive to a predicted electrical charge rate.

13. The method of claim 12, further comprising monitoring previous electrical charge pulse rates provided by the detector.

14. The method of claim 13, further comprising determining a trend in the previous electrical charge pulse rates indicative of an expected electrical charge pulse rate to be produced by the detector.

15. The method of claim 12, wherein the detector comprises at least two sensors receiving energy from the target, each sensor providing respective electrical charge pulses responsive to the received energy, the method further comprising monitoring an electrical charge pulse rate of a first sensor of the detector proximate a second sensor.

16. The method of claim 15, further comprising using the electrical charge pulse rate of the first sensor to predict an expected electrical charge pulse rate of the second sensor.

17. The method of claim 12, further comprising determining geometry of the target corresponding to a position of the detector in relation to the target.

18. The method of claim 17, further comprising determining when the detector is at the position relative to the target.

19. The method of claim 18, further comprising predicting an expected electrical charge pulse rate to be produced by the detector according to the position of the detector relative to the target.

20. The method of claim 12, further comprising:
directing the electrical charge pulses to the charge signal counter when a relatively lower electrical charge pulse rate is expected; and
directing the electrical charge pulses to the charge signal integrator when a relatively higher electrical charge pulse rate is expected.

21. The method of claim 12, wherein the detector is manipulated for progressively scanning the target for acquiring respective imaged slices of the target, the method further comprising monitoring electrical charge pulse rates of previously imaged slices of the target.

22. The method of claim 21, further comprising determining a trend in the electrical charge pulse rates of the previously imaged slices of the target indicative of an expected charge signal rate to be produced by the detector.

23. The method of claim 12, wherein the predicting and directing steps are performed during scanning of the target.

24. The method of claim 12, wherein the detector comprises an x-ray detector receiving energy in the form of x-ray photons.

25. The method of claim 1, further comprising predicting an expected electrical charge pulse rate to be produced by the detector according to statistical data compiled from previously acquired imaging scans.

26. The method of claim 1, further comprising predicting an expected electrical charge pulse rate to be produced by the detector based on a scout scan of the target.

27. The method of claim 1, further comprising predicting an expected electrical charge pulse rate to be produced by the detector according to a desired anatomical region of the target to be imaged.

28. An adaptive imaging method comprising:
automatically predicting an electrical charge pulse rate expected to be produced by a detector receiving energy from a target and providing electrical charge pulses at a rate indicative of an intensity of the received energy;
counting electrical charge pulses produced by the detector and generating a count signal;
integrating the electrical charge pulses produced by the detector and generating an integration signal; and
selectively using the count signal and the integration signal responsive to a prediction of the electrical charge pulse rate expected to be produced by the detector for generating an image.

29. Computer readable media containing program instructions for adaptive imaging, the computer readable media comprising:
a computer program code for automatically predicting an electrical charge pulse rate expected to be produced by a detector receiving energy from a target and providing electrical charge pulses at a rate indicative of an intensity of the received energy; and
a computer program code for selectively directing the charge pulses to a charge counter and a charge integrator responsive to a predicted electrical charge rate.
